(19) United States
(12) Patent Application Publication
(10) Pub. No.: US 2026/0132642 A1
(43) Pub. Date: May 14, 2026

(54) SYSTEM AND METHOD FOR PROJECTING A SOLUTION ONTO A FACADE OF A STRUCTURE

(71) Applicant: KTV Working Drone AS, HAUGLANDSHELLA (NO)

(72) Inventor: Kennet NILSEN, HAUGLANDSHELLA (NO)

(73) Assignee: KTV Working Drone AS, HAUGLANDSHELLA (NO)

(21) Appl. No.: 19/119,609

(22) PCT Filed: Sep. 7, 2023
(86) PCT No.: PCT/NO2023/060046

§ 371 Date: Apr. 9, 2025

(30) Foreign Application Priority Data
Oct. 18, 2022 (NO) 20221115

(51) Int. Cl. E04G 23/00; B05B 13/00; B64U 10/60; B64U 101/29; B66D 3/26

(52) U.S. Cl. CPC E04G 23/002; B05B 13/005; B64U 10/60; B66D 3/26; B64U 2101/29

(57) ABSTRACT

A system and a method for projecting a solution onto a facade of a structure. The system includes: a pump for pumping the solution; a tool for projecting the pumped solution onto the facade; a hose for connecting the pump to the tool; a drone for moving the tool relative to the facade; a hoisting system for being installed on a top of the structure and vertically moving a portion of the hose in front of the facade, the hoisting system having a winch and at least one cable. The at least one cable is connectable to the hose portion so that hose portion and the drone delimit a hose segment with a fixed length.

### CROSS-REFERENCE TO RELATED APPLICATIONS

This application is the U.S. national stage application of International Application No. PCT/NO 2023/060046, filed Sep. 7, 2023, which international application was published on Apr. 25, 2024, as WO 2024/085765 in the English language. The International Application claims priority to Norwegian Ser. No. 20/221,115 , filed Oct. 18, 2022. The international application and Norwegian application are both incorporated herein by reference, in their entirety.

### FIELD

The present invention relates to a system for projecting a solution onto a facade of a structure. The present invention also relates to a method for projecting a solution onto a facade of a structure.

### BACKGROUND

Nowadays, there are various known approaches for cleaning structure's facade, such as a building's facade. Well known approaches include the use of suspended scaffolding, rope access techniques or other devices for suspending and positioning personnel in proximity to the surface being cleaned. Once positioned, the suspended personnel operates cleaning tools and further moves/climbs along the facade. However, the scaffolding/climber approaches have drawbacks, as these typically require suspending human beings at high altitudes with an increased risk of accidents. These conditions require the personnel involved in the cleaning operations to be adequately trained and often that a lot of gear is used, which in usually involves high costs.

A known alternative to the scaffolding/climber approaches is to use a drone for moving and pointing a cleaning tool to the facade surfaces to be cleaned. For example, WO2015150529A1 discloses a cleaning drone that transports a glass cleaning device. The drone approach has several advantages over the climber approach. Firstly, the human operators are not subjected to risk of injury due to falling. Secondly, less effort is required to perform a cleaning operation, as the operator does not need to set up scaffolding, climbing gear or related material. Thirdly, the drone approach enables the conditions necessary for establishing an automated cleaning system. This is advantageous in several respects, such as in reliability, minimizing human lapses, and performing an efficient consumption of water.

However, known approaches using a drone still have challenges. A drone may consume a lot of electrical power due to the flying operations transporting the cleaning tool and respective means for supplying a cleaning solution, such as a hose, which can be quite heavy. Also, a drone may fall while performing facade cleaning operations. This type of accident may happen due to the drone hitting parts of the building, losing power due to drained batteries, or some other reason that causes the drone to lose its flying capabilities. This is highly undesirable, as it requires a lot of effort to fix the problem. For example, the drone or building may be damaged by the fall of the drone, which may require high costs to fix. Also, it may be necessary for someone to travel to the site in order to bring the drone back into operation, which can be expensive and require a lot of time before the drone is back in operation. Furthermore, a falling drone may cause serious injuries to any person being hit by the drone.

### SUMMARY

The invention will now be disclosed and has for its object to remedy or to reduce at least one of the drawbacks of the known prior art, or at least provide a useful alternative to the known prior art. The object is achieved through features, which are specified in the description below and in the claims that follow. The invention is defined by the independent patent claims, and the dependent claims define advantageous embodiments of the invention.

According to a first aspect of the invention, there is provided a system for projecting a solution onto a facade of a structure. The system comprises:
a pump for pumping the solution;
a tool for projecting the pumped solution onto the facade;
a hose for connecting the pump to the tool; and
a drone for moving the tool relative to the facade.

The system further comprises: a hoisting system for vertically moving a portion of the hose in front of the facade, the hoisting system comprising a winch and at least one cable. Also, the at least one cable is connectable to the hose portion so that the hose portion and the drone delimit a hose segment with a fixed length.

The system achieves a combination of functions for the hoisting system and the hose segment. Firstly, the hose supplies the tool that is moved by the drone with the pumped solution to be projected. Secondly, the composition of the hoisting system and the hose segment can serve as a safety rope/tether due to the controllability of the hoisting system and the fixed length of the hose segment. This is useful in case the drone loses its flight capabilities and falls. Thirdly, the hoisting system reduces the load that is applied by the weight of the hose on the drone, which can be quite substantial in practice. Therefore, the hoisting system has a beneficial effect in that the drone will require less power to operate, which in turn results in a need for smaller batteries, a need for a smaller drone, and/or longer operating times.

Optionally, the hoisting system is configurable with a maximum hoisting length so that the maximum hoisting length and the hose segment add up to a total length for suspending the drone in the air. In one embodiment, the total length for suspending the drone in the air is less than a height of the facade. The maximum hoisting length can guarantee that the range of vertical movement of the drone is safely restricted. Thus, should it fall, the drone can be caught by the hoisting system and the hose segment and stay suspended from reaching the level of the facade's bottom limit.

Optionally, the system further comprises a tank for supplying the solution to the pump. Thus, the system can be used even when there is no supply of solution available on site. For example, a tank may be transported on a trailer and used for supplying solution to the pump. After the job is concluded, the system with the tank may be moved to another location.

Optionally, the drone is configurable to perform a flight program when deployed, the flight program causing the drone to travel a pre-defined path relative to the facade. Thus, the system allows performing operations personalized to a structure. For example, flight programs may be configured on the drone so that a solution is projected to any of: only the windows and/or glass surfaces; only the surfaces that are neither windows nor glass surfaces; all surfaces of all facades; or all surfaces of only one of the facades.

Optionally, the hose segment is at most 15 meters long.

According to a second aspect of the invention, there is provided a method for projecting a solution onto a facade of a structure, wherein the method comprises the steps of:
providing a system as described in the first aspect of the invention;
installing the hoisting system on a top of the structure;
connecting the hoisting system to the hose portion;
vertically moving the hose portion in front of the facade;
activating the pump so that the pumped solution is projected from the tool and onto the facade; and
deploying the drone to fly relative to the facade and within a radius from the hose portion, the radius being formed by the hose segment.

Optionally, the deploying step comprises deploying the drone to fly at most up to the height of the hose portion. Thus, the height of hose segment will be mostly held up by the hoisting system, which is advantageous for improving the maneuverability of the drone.

Optionally, the method comprises the step of installing the pump on the top of the structure. The method can therefore be performed with an alternative pump positioning. This embodiment is useful in requiring less powerful hoisting systems. Also, the total length of the hose may be made shorter.

### BRIEF DESCRIPTION OF THE FIGURES

Embodiments of the invention will now be described, by way of example only, with reference to the accompanying drawings, in which:

FIG. 1 shows a system embodiment being used on a building; and

FIG. 2 shows another system embodiment being used on another building.

### DETAILED DESCRIPTION

The drawings are shown in a schematic and simplified manner, and features that are not necessary for explaining the invention may be left out. Identical reference numerals refer to identical or similar features in the drawings. The various features shown in the drawings may not necessarily be drawn to scale.

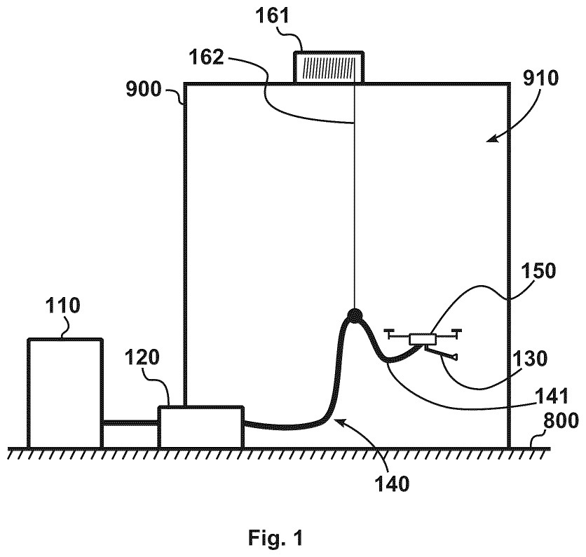

Turning now to FIG. 1, it shows an embodiment of a system according to the present invention. A facade 910 of a structure 900, which in this example is a building 900, is being cleaned with a cleaning solution that is projected from a tool 130 operatively connected to a drone 150 and onto the facade 910. For illustrative purposes, the facade 910 is illustrated as a rectangle shape and the building 900 is illustrated as standing on a ground 800.

A method embodiment according to the present invention is carried out as follows.

The system for projecting the solution onto the facade 910 is provided in situ. The system includes a pump 120 for pumping the solution, the tool 130 for projecting the pumped solution onto the facade 910, a hose 140 for connecting the pump 120 to the tool 130, and the drone 150 for moving the tool 130 relative to the facade 910.

For the system embodiment illustrated in FIG. 1, the following steps were also carried out: providing a tank 110 for supplying the solution to the pump 120; and fluidly connecting the tank 110 to the pump 120. In the situation shown in FIG. 1, it is not possible to obtain a supply of solution available on site, and therefore it was necessary to bring the tank 110 for supplying the necessary solution. However, the skilled person will find that many structures may already include an onsite supply of solution, which would render the step of providing the tank 110 unnecessary in those cases.

Also, the system includes a hoisting system for vertically moving a portion of the hose 140 in front of the facade 910. In FIG. 1, the hoisting system is implemented as a cable 162 and a winch 161 for spooling the cable, wherein the winch 161 controls the length of cable 162 extending out of the winch 161. The following method steps were also carried out: installing the winch 161 of the hoisting system on a top of the building 900; and connecting the hoisting system via the cable 162 to the hose portion so that the hose portion and the drone 150 delimit a hose segment 141 with a fixed length. In FIG. 1, the hose portion is illustrated as a black dot at the end of the cable 162 and connecting the hose 140 to the cable 162.

The skilled person will find that, in other situations, it may be advantageous to set the winch 161 differently. For example, the winch 162 may be set at an intermediate level of the building 900.

The method further carries out the steps of: vertically moving the hose portion in front of the facade 910; activating the pump 120 so that the pumped solution is projected from the tool 130 and onto the facade 910; and deploying the drone 150 to fly relative to the facade 910 and within a radius from the hose portion, the radius being formed by the hose segment 141. In FIG. 1, the drone 150 has been configured with a flight program to fly substantially in parallel to the facade 910, at a substantially constant distance from the facade 910. For example, the configured constant distance may be between 30 cm and 3 meters.

In the embodiment shown in FIG. 1, the winch 162 is configured with a maximum hoisting length, i.e. a maximum length of cable 162 that may be drawn from the winch 162. In particular, the maximum hoisting length is configured so that it adds up with the hose segment 141 to a total length that can effectively suspend the drone 150 in the air in case the drone 150 looses its flying capabilities and falls. That total length is less than the height of the facade 910, in the embodiment shown in FIG. 1.

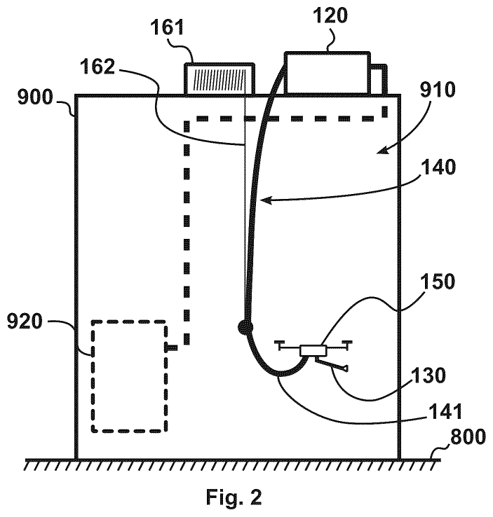

FIG. 2 shows a structure embodiment 900. For illustrative purposes, the structure 900 shown in FIG. 2 may be considered to be any of a building, a house, a monument or an offshore structure. The structure 900 has a facade 910 that has been previously subjected to a detergent solution and is now shown in FIG. 2 being rinsed with a solution mainly having water to remove foam generated by the detergent solution.

The facade 910 is limited at its bottom by an external element 800 that establishes a vertical barrier through which the drone 150 cannot fly. For example, if the structure 900 is considered to be a building, a house or a monument, the facade 910 can be considered to be limited at its bottom by a ground 800. If the structure 900 is considered to be a maritime structure, such as an offshore rig, the facade 910 can be considered to be limited at its bottom by sea water 800.

The structure 900 includes a system for projecting the solution onto a facade 910 of the structure 900. The system is installed on the top surface of the structure 900, for example a roof or a deck. Also, the system includes a pump 120 for pumping the solution, a tool 130 for projecting the pumped solution onto the facade 910, an hose 140 for connecting the pump 120 to the tool 130, a drone 150 for moving the tool 130 relative to the facade 910, and a hoisting system, implemented as winch 161 similarly to FIG. 1, for vertically moving a portion of the hose in front of the facade 910.

In FIG. 2, the structure 900 includes a system 930 for supply the solution being used to rinse off the foam from the detergent solution that has been previously applied. For example, the solution supply system 930 may be available on the structure 900 as a connection from a public water supply or as an internal tank.

In the foregoing description, the skilled person will find many options for the solution that is projected onto the facade. For example, a typical solution when performing cleaning operations on a facade includes a solvent, such as water, added with a detergent product. In other cases, other kinds of solution can be used. In some steps, the solution may consist of water without any additional components dissolved therein.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A system for projecting a solution onto a facade of a structure, wherein the system comprises:
a pump for pumping the solution;
a tool for projecting the pumped solution onto the facade;
a hose for connecting the pump to the tool;
a drone for moving the tool relative to the facade,
a hoisting system for vertically moving a portion of the hose in front of the facade, the hoisting system comprising a winch and at least one cable, and
wherein the at least one cable is connectable to the hose portion so that the hose portion and the drone delimit a hose segment with a fixed length.

2. The system according to claim 1, wherein the hoisting system is configurable with a maximum hoisting length so that the maximum hoisting length and the hose segment add up to a total length for suspending the drone in the air.

3. The system according to claim 2, wherein the facade has a height, and
wherein the total length for suspending the drone in the air is less than the height of the facade.

4. The system according to claim 1, wherein the system further comprises a tank for supplying the solution to the pump.

5. The system according to claim 1,
wherein the drone is configurable to perform a flight program when deployed, the flight program causing the drone to travel a pre-defined path relative to the facade.

6. The system according to claim 1, wherein the hose segment is at most 15 meters long.

7. A method for projecting a solution onto a facade of a structure, wherein the method comprises the steps of:
providing a system as described in claim 1;
installing the hoisting system on a top of the structure;
connecting the hoisting system to the hose portion;
vertically moving the hose portion in front of the facade;
activating the pump so that the pumped solution is projected from the tool and onto the facade; and
deploying the drone to fly relative to the facade and within a radius from the hose portion, the radius being formed by the hose segment.

8. The method according to claim 7, wherein the deploying step comprises deploying the drone to fly at most up to the height of the hose portion.

9. The method according to claim 7, wherein the method comprises the step of:
installing the pump on the top of the structure.

10. The method according to claim 8, wherein the method comprises the step of:
installing the pump on the top of the structure.
